(19) United States
(12) Patent Application Publication
(10) Pub. No.: US 2015/0070894 A1
(43) Pub. Date: Mar. 12, 2015

(54) LAMP STRING APPARATUS AND METHOD OF MANUFACTURING THEREOF

(71) Applicant: Sheng-Yi CHUANG, Hsinchu City (TW)

(72) Inventor: Sheng-Yi CHUANG, Hsinchu City (TW)

(21) Appl. No.: 14/481,032

(22) Filed: Sep. 9, 2014

(30) Foreign Application Priority Data
Sep. 10, 2013 (CN) 201310409262.9

(51) Int. Cl. F21V 31/00; F21V 23/00; F21S 4/00

(52) U.S. Cl. CPC F21V 31/005; F21S 4/001; F21V 23/001
USPC 362/249.06; 29/825

(57) ABSTRACT

A lamp string apparatus and method of manufacturing thereof include a plurality of bases each holding a lighting bulb and including an internal thread portion corresponding to the lighting bulb, a first conductive terminal located on the internal thread portion and a second conductive terminal located at a bottom thereof. The first and second conductive terminals of the bases are electrically connected through at least one conductive wire to form a lamp string. Each base is encased by an outer shell which includes at least one insulation section to cover the base and the conductive wire, and a mask section at the junction of the base and the lighting bulb to tightly couple with the lighting bulb, thereby can prevent liquid from flowing through the base and the conductive wire or through a gap between the base and the lighting bulb, thereby can enhance watertight efficacy.

### FIELD OF THE INVENTION

The present invention relates to a lamp string apparatus and method of manufacturing thereof and particularly to a lamp string apparatus equipped with a watertight shell and a method of manufacturing thereof.

### BACKGROUND OF THE INVENTION

In major festivals (such as Christmas) it is a general practice or custom to decorate buildings or street trees with a great number of lamps serially connected in strings. It usually requires at least one socket connected in series via a conductive wire, then at least one lighting bulb is provided and installed on the socket to finish one ornamental lamp string. The ornamental lamp string thus formed can foster joyful atmosphere and provide colorful and dynamic visual effect. However, the ornamental lamp strings mostly are installed outdoors. In the event of raining water could seep into the lighting bulb or conductive portion of the socket through a crevice between the lighting bulb and the socket, and could cause short circuit and result in malfunction of the lighting bulb, or even cause fire of the power cord.

To solve the aforesaid problem the general ornamental lamp string mostly includes a watertight sleeve to enhance its watertight and sealing efficacy. For instance, Taiwan patent publication No. 293548 discloses an improved double-layer watertight lamp socket structure which includes a socket, a conductive wire, a watertight rubber sleeve, a lighting bulb and a conductive copper base. The socket has a T-shaped shell. The shell includes a barrel seat perpendicular to the conductive wire and a coupling duct horizontally encased the conductive wire. The socket is formed by coupling two opposing segments to hold the conductive copper base. The conductive copper base has a pointed leg extended from the bottom thereof to insert into the conductive wire to connect to the core line of the conductive wire to form electrical connection. The lighting bulb is screwed into the copper base via a helical head. The watertight rubber sleeve is a tubular pliable rubber sleeve with a lower rim clamping or encasing the conductive copper base, and an upper rim encasing the lower half portion of the lighting bulb and compressing the upper rim of the barrel seat.

The aforesaid double-layer watertight lamp socket structure mainly has the watertight sleeve clamped between the lighting bulb and the barrel seat. Since the lighting bulb is screwed for anchoring via the helical head, and the watertight rubber sleeve is pliable, during screwing the watertight rubber sleeve is prone to be twisted and moved, and could not tightly press between the lighting bulb and the barrel seat. As a result, water could seep in between the lighting bulb and the barrel seat.

### SUMMARY OF THE INVENTION

The primary object of the present invention is to provide an outer shell which is integrally formed with a lamp socket to achieve watertight efficacy.

To achieve the foregoing object the invention provides a method of manufacturing lamp string apparatus that includes: a step of fabricating a plurality of bases, a step of fabricating a conductive wire and a step of fabricating a plurality of outer shells. The step of fabricating a plurality of bases includes forming the plurality of bases each holding a lighting bulb; each base includes an internal thread portion corresponding to the lighting bulb, a first conductive terminal located on the internal thread portion and a second conductive terminal located therein and at a bottom thereof. The first conductive terminal and the second conductive terminal have respectively an electrical connection end exposed outside the base. The step of fabricating a conductive wire includes providing at least one conductive wire to form electrical connection with the electric connection ends of the first conductive terminal and the second conductive terminal of each base to form a lamp string. The step of fabricating a plurality of outer shells includes encasing the base with the outer shell made from insulating material. The outer shell, includes at least one insulation section to cover the electric connecting location of the base and the conductive wire, and a mask section located on the junction of the base and the lighting bulb to form compact coupling with the lighting bulb.

In one aspect the step of fabricating a conductive wire is preceded by forming a wire connecting section at a preset distance on a conductive wire, and the electric connection end has a connection segment to hold and connect to the wire connecting section.

In another aspect at the step of fabricating a conductive wire includes using a compression member to make the electric connection ends of the first conductive terminal and the second conductive terminal to pierce and form electric connection with the conductive wire.

In yet another aspect at the step of fabricating an outer shell includes forming a hook on each insulation section outside the bottom of each base.

In yet another aspect the lighting bulb includes an electric contact seat electrically connected to each base and a lighting shell which has a neck portion connected to the electric contact seat, and the neck portion is covered by the mask section.

In yet another aspect the mask section is extended to cover a part of the lighting shell adjacent to the neck portion.

In yet another aspect the step of fabricating a plurality of outer shells includes forming at least one jutting ring on an inner wall surface of the mask section in contact with the lighting bulb.

In yet another aspect the step of fabricating a plurality of bases includes forming a flange by extending the internal thread portion outward, and the step of fabricating a plurality of outer shells includes forming a sealing portion by extending the mask section to fully encase the flange.

In addition, the present invention also provides a lamp string apparatus fabricated through the manufacturing method set forth above.

The invention, through the aforesaid techniques, compared with the conventional techniques, can achieve many advantages; notably:

1. Prevent liquid from flowing through the electric connecting location of the base and the conductive wire or between the lighting bulb and the base.

2. Sealing tightness can be enhanced.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a flowchart of the method of manufacturing lamp string apparatus of the invention.

FIG. 2 is an exploded view of a first embodiment he lamp string apparatus according to the invention.

FIG. 3 is a sectional view of the first embodiment of the lamp string apparatus according to the invention.

FIG. 4 is a sectional view of a second embodiment of he lamp string apparatus according to the invention.

FIG. 5 is a top view of the second embodiment of the lamp string apparatus according to the invention.

FIG. 6 is a sectional view of a third embodiment of the lamp string apparatus according to the invention.

FIG. 7 is a sectional view of a fourth embodiment of the lamp string apparatus according to the invention.

### DETAILED DESCRIPTION OF THE PREFERRED EMBODIMENTS

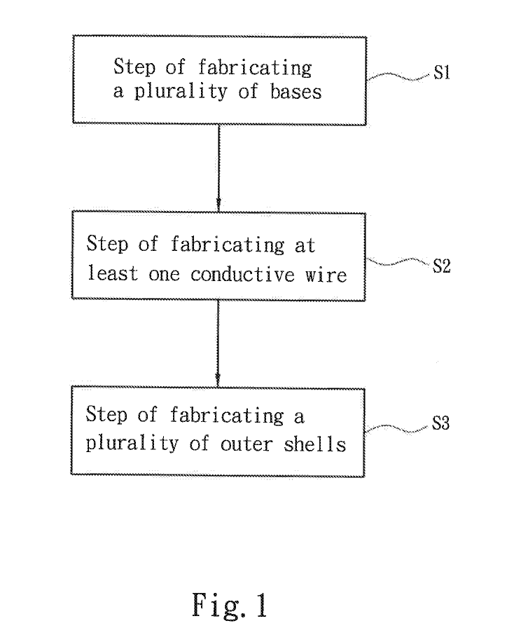

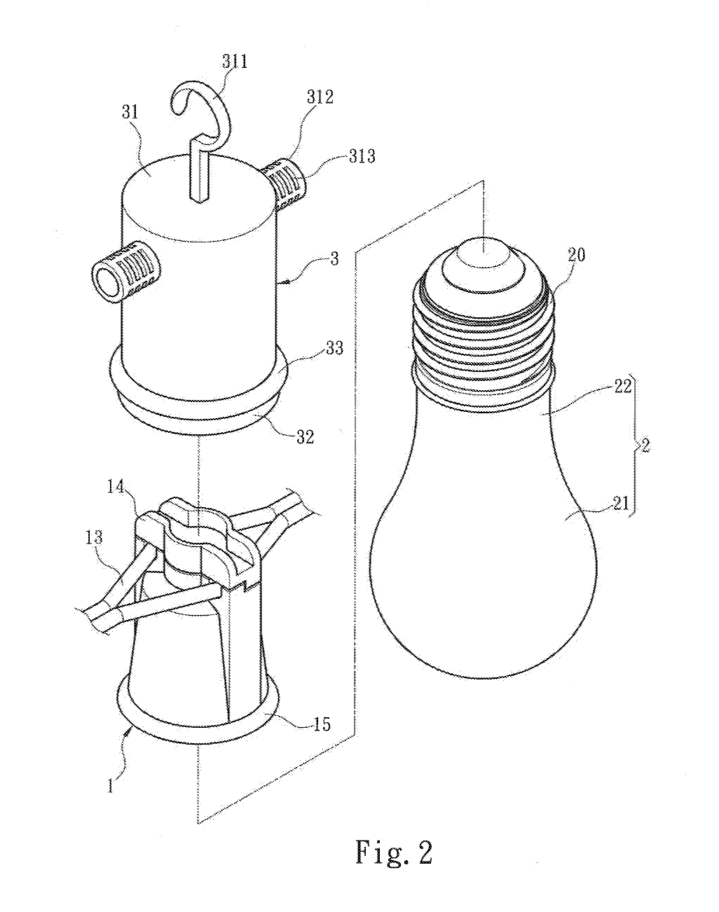

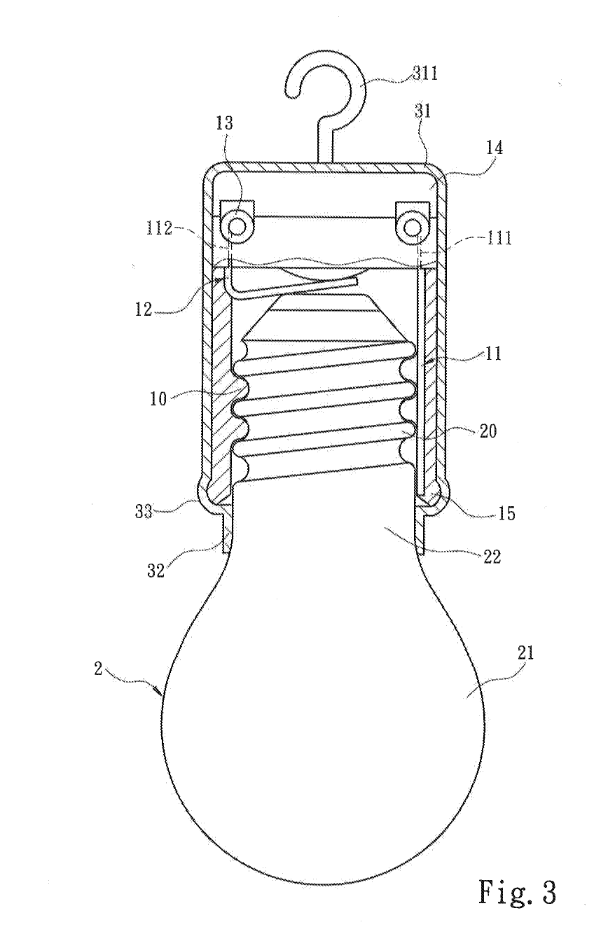

Please referring to FIGS. 1, 2 and 3, the present invention aims to provide a lamp string structure and method of manufacturing thereof. The method of manufacturing the lamp string apparatus that includes: step S1: fabricating a plurality of bases, step S2: fabricating a conductive wire and step S3: fabricating a plurality of outer shells. The step S1 of fabricating a plurality of bases includes forming (such as injection) the plurality of bases 1 each holding a lighting bulb 2. Each lighting bulb 2 includes an electric contact seat 20 electrically connected to the base 1, a lighting shell 21 and a neck portion 22 to bridge the lighting shell 21 and the electric contact seat 20. Each base 1 includes an internal thread portion 10, a flange 15 extended outward from the internal thread portion 10, a first conductive terminal 11 located on the internal thread portion 10, and a second conductive terminal 12 located therein and at a bottom thereof. The first conductive terminal 11 and the second conductive terminal 12 have respectively an electric connection end 111 and 112 exposed outside the base 1. At the step S2 of fabricating a conductive wire the electric connection ends 111 and 112 of each base 1 are pierced through and electrically connected to at least one conductive wire 13 via using a compression member 14, so as to form a lamp string.

The step S3 of fabricating a plurality of outer shells is to form the plurality of outer shells 3 through injection of an insulation material to encase the base 1. The outer shell 3 includes an insulation section 31 and a mask section 32. The insulation section 31 encases at least the electric connecting location of the base 1 and the conductive wire 13. The mask section 32 is located at the junction of the base 1 and each lighting bulb 2 (i.e., the neck portion 22) and formed in a profile mating the lighting bulb 2. For instance, the mask section 32 is formed in a diameter smaller or equal to the diameter of the lighting bulb 2 so that the mask section 32 can be coupled on the junction of the base 1 and the lighting bulb 2 in a compact manner. The insulation section 31 and the mask section 32 can be formed separately to encase the base 1 or the junction of the base 1 and the lighting bulb 2, or integrally formed to fully encase the base 1. Moreover, the insulation section 31 that covers the conductive wire 13 includes an encasing section 312. The encasing section 312 has a plurality of trenches 313 so that the encasing section 312 can cover a portion of the conductive wire 13, and the trenches 313 provide flexibility to allow the conductive wire 13 to swivel as desired. In addition, the mask section 32 is extended to form a sealing portion 33. In the event that the insulation section 31 and the mask section 32 are formed in an integrated manner the sealing portion 33 is located between the insulation section 31 and the mask section 32 so that the flange 15 of the base 1 can be fully covered. Furthermore, the insulation section 31 also has a hook 311 formed on an outer side thereof corresponding to the bottom of the base 1.

In this embodiment each base 1 forms a lamp string through the conductive wire 13, and the outer shell 3 is formed by injection on the base 1. The electric contact seat 20 of each lighting bulb 2 is engaged with the internal thread portion 10 of the base 1. The insulation section 31 of the outer shell 3 covers the electric connecting location of the base 1 and the conductive wire 13. The sealing portion 33 fully covers the flange 15 of the base 1. The mask section 32 is tightly coupled on the neck portion 22 of the lighting bulb 2 so that the outer shell 3 can encase in a closely contact manner the base 1 and the junction of the base 1 and the lighting bulb 2, thereby can prevent liquid from flowing through a gap formed between the internal thread portion 10 and the electric contact seat 20, or through the electric connecting location of the base 1 and the conductive wire 13, thus can enhance watertight efficacy.

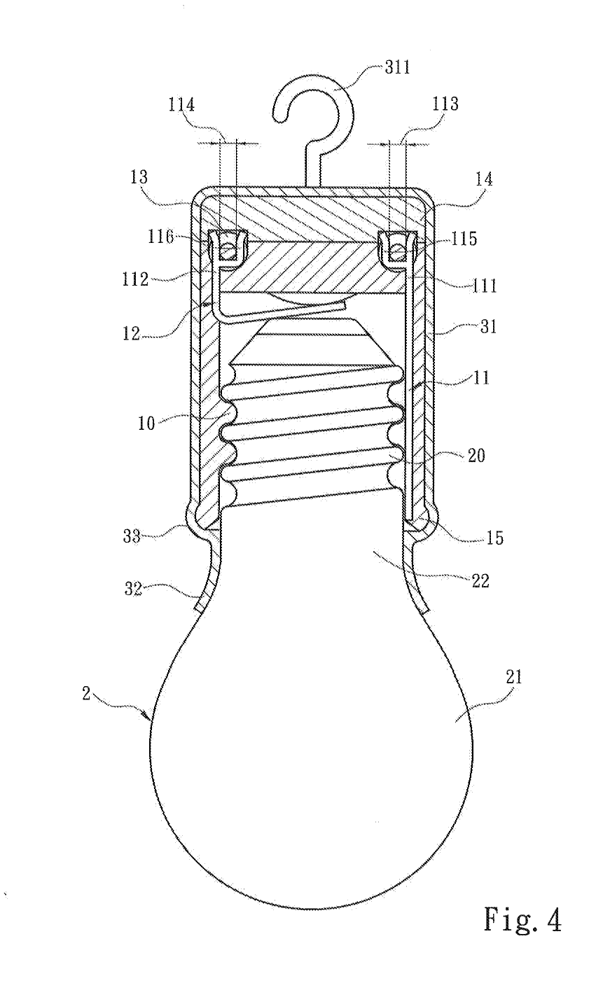

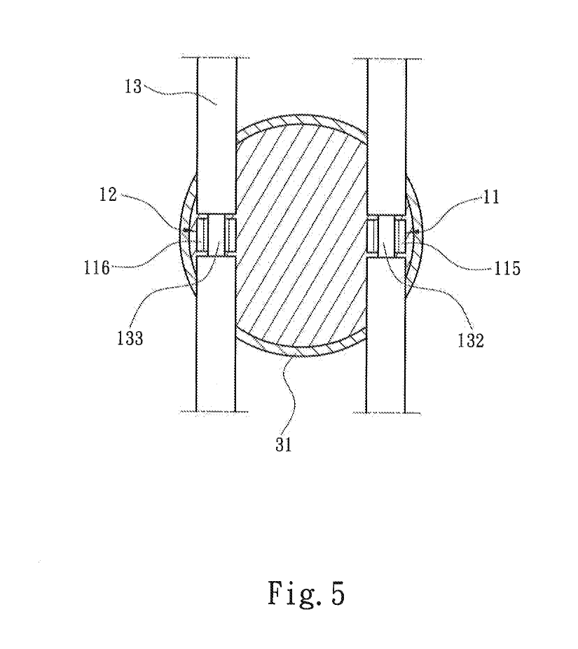

Please refer to FIGS. 4 and 5 for a second embodiment of the invention. It is substantially same as the first embodiment previously discussed. It mainly differs at the step S2 of fabricating a conductive wire. First, the conductive wire 13 is formed wire connecting sections 132 and 133 according to a preset interval 131, and the electric connection ends 111 and 112 have respectively a connection segment 113 and 114 to hold and connect to the wire connecting sections 132 and 133. More specifically, the electric connection ends 111 and 112 are exposed outside the base 1, and can further be formed respectively in a substantially U-shaped receiving portion 115 and 116 where the connection segments 113 and 114 are formed. The conductive wire 13, through the wire connecting sections 132 and 133, can latch on the receiving portions 115 and 116, and be held on the connection segments 113 and 114 so that the conductive wire 13 at the wire connecting sections 132 and 133 can form electric connection with the electric connection ends 111 and 112.

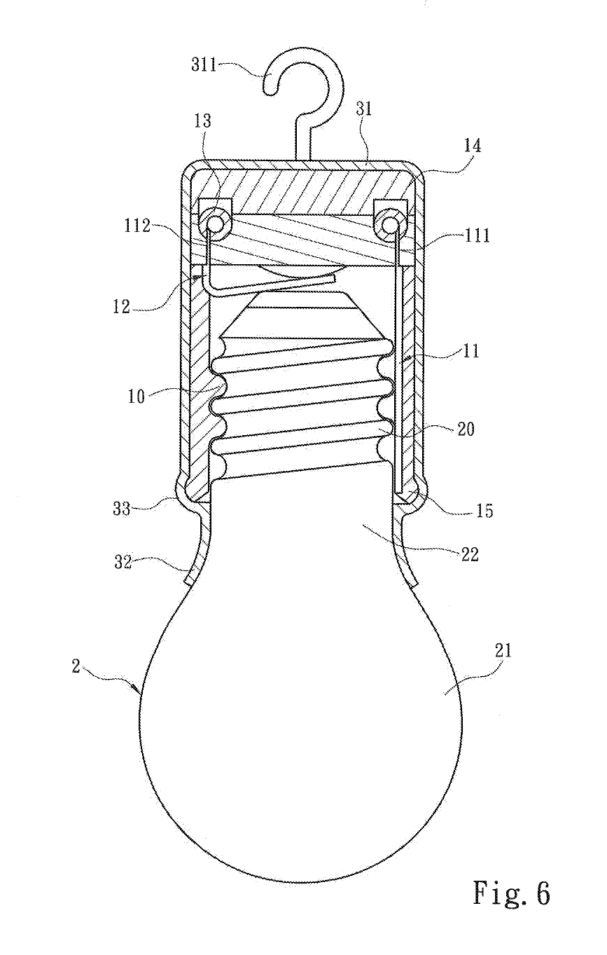

Please refer to FIG. 6 for a third embodiment of the invention. It is substantially same as the first embodiment previously discussed. It mainly differs at the step S3 of fabricating a plurality of outer shells. Aside from making the mask section 32 to form tight coupling with the neck portion 22 of the lighting bulb 2, the mask section 32 also can be extended to cover a part of the lighting shell 21 adjacent to the neck portion 22, i.e., the mask section 32 can be extended from the neck portion 22 to cover a part of the lighting shell 21, hence can fully cover the lighting bulb 2 in a closely contact manner.

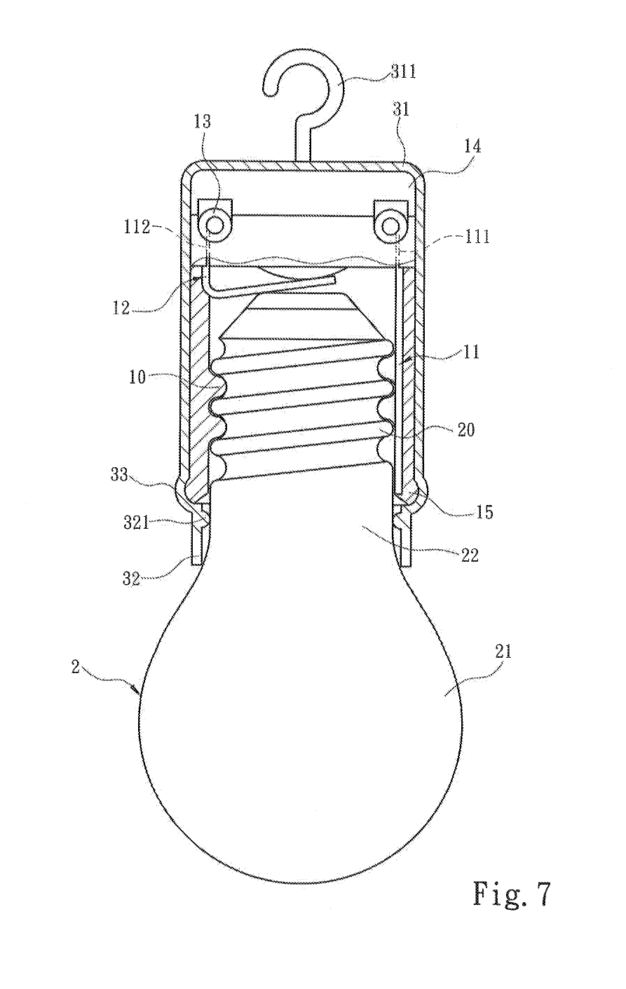

Please refer to FIG. 7 for a fourth embodiment of the invention. It is substantially same as the first embodiment previously discussed. It mainly differs at the step S3 of fabricating a plurality of outer shells. The mask section 32 further has at least one jutting ring 321 firmed on an inner wall surface thereof in contact with the lighting bulb 2. When the electric contact seat 20 of each lighting bulb 2 is screwed on the internal thread portion 10 of the base 1 the jutting ring 321 can press the base I and the lighting bulb 2 to enhance coupling tightness.

As a conclusion, the lamp string apparatus and method of manufacturing thereof mainly include a plurality of bases each holding a lighting bulb. Each base includes an internal thread portion corresponding to the lighting bulb, a first conductive terminal located on the internal thread portion and a second conductive terminal located on the inner side of the bottom of the base. The first conductive terminal and the second conductive terminal have respectively an electric connection end exposed outside the base. The electric connection ends of the first conductive terminal and the second conductive terminal are electrically connected through at least one conductive wire to form a lamp string. The base is encased by an outer shell made from an insulation material. The outer shell includes at least one insulation section to cover the electric connecting location of the base and the conductive wire, and a mask section located at the junction of the base and the lighting bulb to form tight contact with the lighting bulb, thereby can prevent liquid from flowing through the electric connecting location of the base and the conductive wire or the gap between the base and the lighting bulb, hence can enhance watertight efficacy.

What is claimed is:

1. A method of manufacturing a lamp string apparatus, comprising the steps of:
fabricating a plurality of bases each holding a lighting bulb and including an internal thread portion corresponding to the lighting bulb, a first conductive terminal located on the internal thread portion and a second conductive terminal located therein and at a bottom thereof, the first conductive terminal and the second conductive terminal including respectively an electric connection end exposed outside the base;
fabricating at least one conductive wire which is electrically connected to the electric connection ends of the first conductive terminal and the second conductive terminal of each of the bases to form a lamp string; and
fabricating a plurality of outer shells each made from insulation material to encase the base and including at least one insulation section to cover electric connecting location of the base and the conductive wire and a mask section located at a junction of the base and the lighting bulb to form tight coupling with the lighting bulb.

2. The method of manufacturing a lamp string apparatus of claim 1, wherein the step of fabricating at least one conductive wire firstly defines a wire connecting section at a preset interval on the conductive wire, and each electric connection end including a connection segment to hold and electrically connect to the wire connecting section.

3. The method of manufacturing a lamp string apparatus of claim 1, wherein the step of fabricating at least one conductive wire includes using a compression member to make the electric connection ends of the first conductive terminal and the second conductive terminal to pierce and form electrical connection with the conductive wire.

4. The method of manufacturing a lamp string apparatus of claim 1, wherein the step of fabricating a plurality of outer shells includes forming a hook at an outer side of the insulation section corresponding to the bottom of the base.

5. The method of manufacturing a lamp string apparatus of claim 1, wherein the lighting bulb includes an electric contact seat electrically connected to the interior of the base and a lighting shell, a junction of the lighting shell and the electric contact seat being defined as a neck portion which is covered by the mask section,

6. The method of manufacturing a lamp string apparatus of claim 5, wherein the mask section further is extended to cover a part of the lighting shell adjacent to the neck portion.

7. The method of manufacturing a lamp string apparatus of claim 5, wherein the step of fabricating a plurality of outer shells includes forming at least one jutting ring on an inner wall surface of the mask section in contact with the lighting bulb.

8. The method of manufacturing a lamp string apparatus of claim 5, wherein the step of fabricating a plurality of bases includes forming a flange extended outward from the internal thread portion of each base, and the step of fabricating a plurality of outer shells includes forming a sealing portion extended from the mask section to fully cover the flange.

9. A lamp string apparatus fabricated according to the method of claim 1.

10. A lamp string apparatus fabricated according to the method of claim 2.

11. A lamp string apparatus fabricated according to the method of claim 3.

12. A lamp string apparatus fabricated according to the method of claim 4,

13. A lamp string apparatus fabricated according to the method of claim 5.

14. A lamp string apparatus fabricated according to the method of claim 6.

15. A lamp string apparatus fabricated according to the method of claim 7.

16. A lamp string apparatus fabricated according to the method of claim 8.
